(19) United States
(12) Patent Application Publication
(10) Pub. No.: US 2010/0080464 A1
(43) Pub. Date: Apr. 1, 2010

(54) IMAGE CONTROLLER AND IMAGE CONTROL METHOD

(75) Inventors: Susumu Sawai, Kawasaki (JP); Kazuo Ishida, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/567,309

(22) Filed: Sep. 25, 2009

(30) Foreign Application Priority Data
Sep. 30, 2008 (JP) 2008-255523

(51) Int. Cl. G06K 9/46

(52) U.S. Cl. 382/190

(57) ABSTRACT

An image controller includes a position detection unit which detects a position of a viewer's face or eyes and an image control unit which controls an object image displayed on a screen in response to a change in the position of the face or the eyes detected by the position detection unit.

### CROSS-REFERENCE TO RELATED APPLICATIONS

This application is based upon and claims the benefit of priority of the prior Japanese Patent Application No. 2008-255523, filed on Sep. 30, 2008, the entire contents of which are incorporated herein by reference.

### FIELD

Certain aspects of the present invention discussed herein are related to an image controller and an image control method for controlling an object displayed on a screen in response to a change in position of a viewer's face or eyes.

### BACKGROUND

A mouse or a keyboard has been generally used for performing an input operation to a computer. Recently, however, techniques have been developed that detect information on movements of an operator as input for a computer without using a mouse or a keyboard, and control images on a screen in response to intuitive movements of the operator.

For example, Japanese Laid-open Patent Publication No. 8-22385 discusses a technique that controls an image display screen in response to a change in position of an operator's line of sight. More specifically, the technique detects a position of an operator's line of sight, and scrolls the screen if the movement of the position of line of sight exceeds a given speed.

### SUMMARY

According to an aspect of the invention, an image controller includes a position detection unit which detects a position of a viewer's face or eyes and an image control unit which controls an object image displayed on a screen in response to a change in the position of the face or the eyes detected by the position detection unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a configuration of an image controller according to a first embodiment;

FIG. 2 illustrates processing of face recognition of a viewer;

FIG. 3 is a block diagram illustrating processing of recognizing a main viewer;

FIG. 4 illustrates processing of controlling a television (TV) screen;

FIG. 5 illustrates an example of changing a TV screen;

FIG. 6 illustrates an example of changing a TV screen;

FIG. 7 illustrates an example of changing a TV screen;

FIG. 8 illustrates an example of changing a TV screen;

FIG. 9 illustrates an example of changing a TV screen;

FIG. 10 illustrates an example of changing a TV screen;

FIG. 11 is a flowchart illustrating processing procedures of an image controller according to the first embodiment;

FIG. 12 is a flowchart illustrating processing procedures of detecting a main viewer by the image controller according to the first embodiment;

FIG. 13 is a flowchart illustrating processing procedures of controlling a TV screen by the image controller according to the first embodiment; and

FIG. 14 illustrates a computer executing the image control program.

### DESCRIPTION OF EMBODIMENTS

Embodiments for an image controller, an image control program and an image control method according to an aspect of the invention are described with reference to the accompanying drawings.

### First Embodiment

In the embodiments below, first, a configuration and a processing flow of an image controller according to a first embodiment will be described, and then an effect of the first embodiment will be described. Hereunder, scrolling a screen and rotating an object in response to a change in position of a user's eyes will be described.

Configuration of an Image Controller

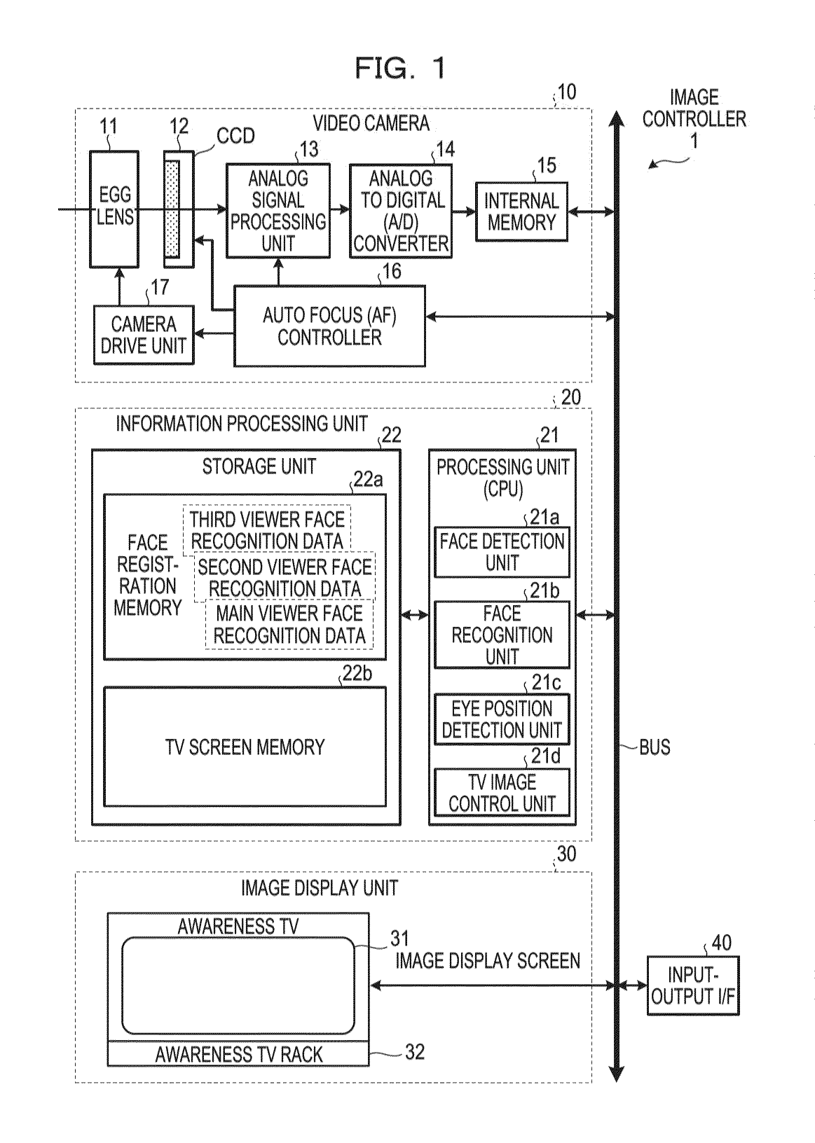

First, a configuration of an image controller 1 will be described by referring to FIG. 1. FIG. 1 is a block diagram illustrating a configuration of an image controller 1 according to a first embodiment. As illustrated in FIG. 1, the image controller 1 includes a video camera 10, an information processing unit 20, and an image display unit 30, and each of these are coupled via a bus, etc.

In the image controller 1, the video camera 10 with an egg-shaped EGG lens 11 captures an image. Then the information processing unit 20 processes the captured image to create an entire circumferential panorama image and displays the image on the image display unit. Processing by each of these units will be described below.

The video camera 10 captures images of a viewer and images that the viewer watches on the image display unit 30, and transmits the image data to the information processing unit 20. The video camera 10 includes the EGG lens 11, a charge-coupled device (CCD) image sensor 12, an analog signal processing unit 13, an analog to digital (A/D) converter 14, an internal memory 15, an auto focus (AF) controller 16, and a camera drive unit 17.

The EGG lens 11 is an egg-shaped lens for capturing an entire circumferential image in a torus-shape. The CCD image sensor 12 generates picture signals by photo-electrically converting a subject image captured by a photographic optical system and outputs the signals to the analog signal processing unit 13. Now, coordinates of picture signals will be described. Coordinates (0, 0, 0) indicate an upper left corner of a screen, whereas coordinates (x, y, 0) indicate a lower right corner of the screen.

The analog signal processing unit 13 applies various processing such as a sensitivity correction or a white balance to the picture signals output from the CCD image sensor 12 and inputs the picture signals to the A/D converter 14. The A/D converter 14 converts the picture signals output from the analog signal processing unit 13 to digital signals and inputs the signals for the entire circumferential panoramic image of the captured image to the internal memory 15.

The internal memory 15 stores the entire circumferential panoramic image of the captured image output from the analog signal processing unit 13. The AF controller 16 controls processing and operations related to focusing by each unit. The camera drive unit 17 drives and controls the EGG lens 11 so that an entire circumferential video image may be captured.

The information processing unit 20 stores an image captured by the video camera 10, detects a viewer's face and eyes, and controls the image displayed on the image display unit 30. The information processing unit 20 includes a processing unit 21 and a storage unit 22.

The storage unit 22 stores data and programs required for processing by a processing unit 21. The storage unit 22 includes a face registration memory 22a and a TV screen memory 22b.

The face registration memory 22a records face recognition data that is generated based on feature points of persons' faces by associating the respective data with index image data that indicates a person who corresponds to the face recognition data. For example, the face registration memory 22a stores eigenfaces that are face recognition data of viewers (a set of eigenvectors A), an average face (a vector of average value x), and a set of face feature vectors {Ωₖ}. The eigenfaces and the average face are required for calculating a face feature vector of an unknown input image (expansion coefficient Ω), whereas the face feature vector is required for calculating a Euclidean distance.

Now, eigenfaces (a set of eigenvectors A), an average face (vector of average value x), and a set of face feature vectors required for calculating a Euclidean distance that are stored in the face registration memory 22a will be described. First, a density value of face recognition data of viewers (face recognition data of the k-th viewer among the number of n₁ viewers, hereunder called “face recognition data”) taken from the video camera 10 is expressed by a two-dimensional array f(i, j) and X₁ is obtained by making the two-dimensional array into one-dimensional array. When the size of face recognition data is m₁Xm₁ pixels, the following Expression (1) is obtained:

Expression 1

l=i+m₁(j−1) (i,j=1,2, . . . , m₁) (1)

When (a vector of density values of) the number of n₁ pieces of face recognition data is represented by xₖ, the following expression (2) is obtained. Note that “M₁=m₁Xm₁” indicates the total number of pixels, “K” indicates index image data of face recognition data, and “l” indicates the pixel number when images of the two-dimensional array are arranged in a line starting from the upper left.

Expression 2

xₖ=(xₖ₁,xₖ₂, . . . , x_{kM}_{₁})^{T} (k=1, 2, . . . , n₁) (2)

A matrix X for an entire xₖ as represented in the following expression (3) is called a “matrix of face density values”. From the matrix of face density values X, a variance-covariance matrix S is obtained, then an eigenvalue λᵢ and an eigenvector a₁ (i=1,2, . . . L) are calculated. As represented in the following expression (4), a matrix A consisting of eigenvectors becomes a transformation matrix of an orthonormal basis.

$$\begin{matrix}Expression 3 & \\ X = ( \begin{matrix}{x}_{11 ,} & {x}_{21 ,} & … , & {x}_{{n }_{1} 1} \\ {x}_{12 ,} & {y}_{22 ,} & … , & {x}_{{n}_{1} 2} \\ … & … & … & … \\ … & … & … & … \\ {x}_{1 {M}_{1} ,} & {x}_{2 {M}_{1} ,} & … , & {x}_{{n}_{1} {M}_{1}}\end{matrix} ) & ( 3 ) \\ Expression 4 & \\ A = ( {a}_{1 ,} {a}_{2 ,} … , {a}_{L} ) & ( 4 )\end{matrix}$$

An eigenvector for a face image is specifically called an “eigenface.” As represented by the following expression (5), an expansion coefficient is calculated from an inner product between each face recognition data xₖ and an eigenface aᵢ. A vector of average values x is called an “average face.” The expansion coefficient and the eigenface enable to restore each face recognition data, thus a vector of expansion coefficients “Ω K” as represented in the following expression (6) is called a “face feature vector.”

Expression 5

┐ₖⱼ=aᵢ^{T}(xₖ−x) (5)

Expression 6

Ωₖ=(┐ₖ₁, ┐ₖ₂, . . . , ┐ₖ₁) (6)

Now, returning to the explanation of FIG. 1, the TV screen memory 22b stores an entire circumferential panorama image captured by the video camera 10. More specifically, the TV screen memory 22b stores an eigen TV screen (a set of eigenvectors B), an average TV screen (vector of average values y), and a set of feature vectors of TV screens Ωₖ. The eigen TV screen (a set of eigenvectors B) and the average TV screen (a vector of average values y) are awareness TV screen data and are required for calculating a feature vector of the TV screen (an expansion coefficient Ωₖ), and a set of a feature vectors of TV screen {Ωₖ} is required for calculating Euclidean distance.

Now, the eigen TV screen (a set of eigenvectors B), and the average TV screen (a vector of average values y), and a set of feature vectors of TV screen {Ωₖ} required for calculating a Euclidean distance that are stored in the face registration memory 22a will be described.

First, a density value of awareness TV screen data taken from the video camera 10 is expressed as two-dimensional array g(i, j) and y₁ is obtained by making the two-dimensional array into a one dimensional array. When a size of a TV screen data is m₂×m₂ pixels, Expression 1 is applied.

When (a density value of) the number of n₂ TV screen data is represented by yₖ, Expression (7) is applied. Note that “M₂=m₂×m₂” indicates the total number of pixels, “K” indicates index image data of TV screen data, and “l” indicates the pixel number when images of the two-dimensional array are arranged in a line starting from the upper left.

Expression 7

yₖ=(yₖ₁,yₖ₂, . . . ,yₖ₁, . . . y_{kM}₂)^{T} (k=1,2, . . . , n₂) (7)

A matrix Y for an entire yₖ as represented in the following Expression (8) is called a matrix of TV screen density values. From the matrix of TV screen density values Y, a variance-covariance matrix s is obtained, then an eigenvalue λᵢ, and an eigenvector bᵢ (i=1,2 . . . L) are calculated. As represented in the following Expression (9), a matrix B consisting of eigenvectors become a transformation matrix of an orthonormal basis as represented by Expression (9) below.

$$\begin{matrix}Expression 8 & \\ Y = ( \begin{matrix}{y}_{11 ,} & {y}_{21 ,} & … , & {y}_{{n }_{2} 1} \\ {y}_{12 ,} & {y}_{22 ,} & … , & {y}_{{n}_{2} 2} \\ … & … & … & … \\ … & … & … & … \\ {y}_{1 {M}_{2} ,} & {y}_{2 {M}_{2} ,} & … , & {y}_{{n}_{2} {M}_{2}}\end{matrix} ) & ( 8 ) \\ Expression 9 & \\ B = ( {b}_{1 ,} {b}_{2 ,} … , {b}_{L} ) & ( 9 )\end{matrix}$$

An eigenvector of a TV screen image is called an “eigen TV screen.” As represented by the following Expression (10), an expansion coefficient is calculated from an inner product between each TV screen recognition data yₖ and an eigen TV screen bᵢ.

Expression 10

┐ₖⱼ=bᵢ^{T}(yₖ−y) (10)

A vector of average values y is called an “average TV screen”. By using the expansion coefficient and the eigen TV screen, each TV screen recognition data may be restored, thus a vector of expansion coefficients Ωₖ as represented in the following expression (11) is called a “TV screen feature vector.”

Expression 11

Ωₖ=(┐ₖ₁,┐ₖ₂, . . . , ┐ₖ₁) (11)

An unknown input image may be restored using a vector of density values that is made into a one dimensional array, thus, a feature vector of TV screen Ω is obtained from an inner product between the eigen TV screen and bᵢ using the following expression (12). Note that, as represented in the following expression (13), the vector of average values y is an average TV screen obtained from TV screen face recognition data.

Expression 12

Ω=(┐₁, ┐₂, . . . , ┐₁)^{T} (12)

Expression 13

┐ᵢ=bᵢ^{T}(y−y) (13)

Now, returning to the explanation of FIG. 1, the control unit 21 includes an internal memory for storing a program that specifies various processing procedures and required data and executes various processing using these programs and data. The control unit 21 includes a face detection unit 21a, a face recognition unit 21b, an eye position detection unit 21c, and a TV image control unit 21d.

The face detection unit 21a detects a face area of a screen based on a viewer's image recorded by the video camera 10, and extracts feature points of the viewer from the face area and notifies the face recognition unit 21b.

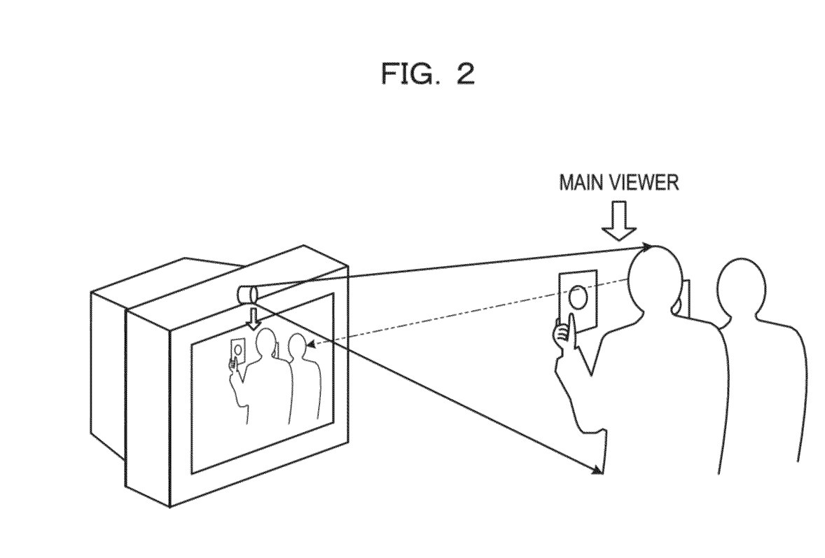

The face recognition unit 21b determines who is a main viewer from among a plurality of viewers based on feature points and face recognition data detected by the face recognition unit 21a. The main viewer may be the person nearest to the image display unit 30 and the viewer whose face is in the front of a group of people from the view point of the image display unit 30, or the viewer with the largest face area among the viewers may be recognized as the main viewer as illustrated in FIG. 2. Then, the face recognition unit 21b notifies the eye position detection unit 21c of the recognized main viewer.

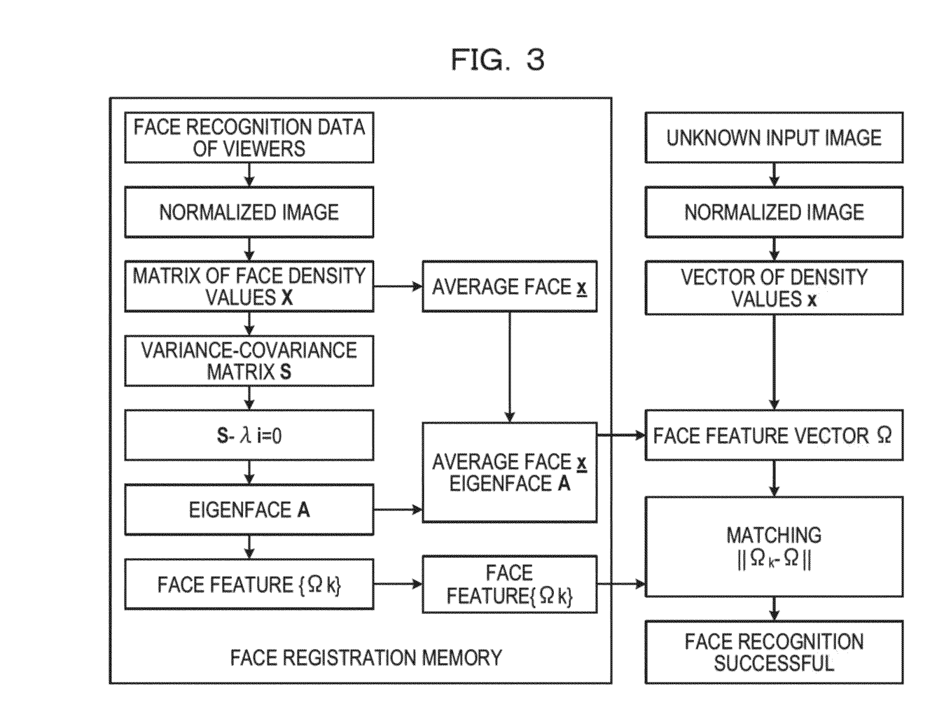

Now, processing of face recognition will be described by referring to FIG. 3. As illustrated in FIG. 3, the face recognition unit 21b calculates a vector of density values X that is made into the one-dimension array for an image of a viewer recorded by the video camera 10 (“unknown input image” in FIG. 3), and generates a face feature vector Ω from an inner product between the vector of density values x and eigenface aᵢ as represented in the following expression (14).

Note that the vector of average values x is an average face obtained from the face recognition data.

Expression 14

Ω=(┐₁,┐₂, . . . , ┐₁)^{T} (14)

Expression 15

┐ᵢ=aᵢ^{T}(x−x) (15)

The face recognition unit 21b uses Euclidean distance for evaluating a face matching, identifies a person with a face feature vector Ωₖ (index image data of face recognition data “k”) when a distance “dₑ” is the shortest, and then recognizes the person as a main viewer.

$$\begin{matrix}Expression 16 & \\ {{{d}_{e} = ‖ {Ω}_{k} - Ω ‖ = \sqrt{ } {\sum }_{i = 1}^{1} {( ⌉}_{ki} - ⌉}_{i} )}^{2} & ( 16 )\end{matrix}$$

The eye position detection unit 21c detects a position of a viewer's face or eyes. The eye position detection unit 21c detects a position of the viewer's eyes and whether or not there is any direct eye contact by the viewer. In other words, the eye position detection unit 21c checks whether or not the main viewer is gazing directly at the screen on which an image is displayed.

As a result, if the eye position detection unit 21c determines there is direct eye contact by the main viewer, then the unit 21c detects the position of the main viewer's eyes at a given detection interval, and determines whether or not the position of the viewer's eyes moves or not. The above described determination of direct eye contact may not be performed if checking whether or not the viewer is gazing at the display screen is unnecessary. In this embodiment, the term “eye” may refer to the part of the eye such as the pupil of the eye as well as the entire eye.

As a result, when the position of the main viewer's face or eyes moves, the eye position detection unit 21c notifies the TV image control unit 21d of the movement difference. The movement of the position of the face or eyes here differs from the movement of the line of sight discussed in the above patent document 1. The movement of the position of the face or eyes means a movement of a position of the face or eyes in image data recorded by the video camera 10. For example, when a position of a face or eyes in an image is represented by coordinates, the movement is represented by a change in coordinates at every given detection interval.

The TV image control unit 21d controls an object image displayed on a screen in response to a change in position of the face or eyes. For example, when the TV image control unit 21d receives a movement difference from the eye position detection unit 21c, the TV image control unit 21d controls the object image displayed on the screen based on the received movement difference.

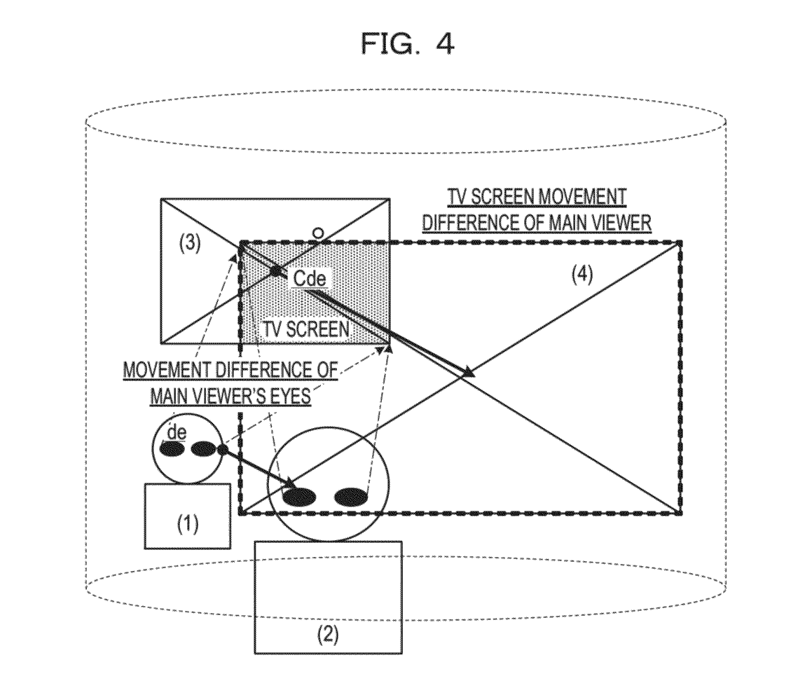

Now, processing of TV image control will be described by referring to the example in FIG. 4. As illustrated in FIG. 4, when a main viewer at a position (1) moves to a position (2) in order to watch an upper left part (3), the TV image control unit 21d controls the screen so that the part that the viewer wants to watch is enlarged and moves close to the viewer on the upper right part (4).

When a movement difference from a position of the eyes of the main viewer at position (1) and that of position (2) is a Euclidean distance dₑ, the TV image control unit 21d assumes that the movement difference of the image display screen 31 position (3) to the image display screen 31 position (4) is Cde (constant C times the Euclidean distance dₑ). The constant C is determined by the size (the number of inches) of a TV screen.

In other words, the TV image control unit 21d uses a constant C of a Euclidean distance dₑ that reflects a movement difference of a position of the viewer's eyes in order to move the TV screen. A user sets the constant C at an initial setting of the image display unit 30 depending on the size of the image display screen 31 of the image display unit 30. Thus, the amount of movement difference of TV screen is obtained by the following expression (17):

$$\begin{matrix}Expression 17 & \\ {{{Cd}_{e} = C ‖ {Ω}_{k} - Ω ‖ = C \sqrt{ } {\sum }_{i = 1}^{1} {( ⌉}_{ki} - ⌉}_{i} )}^{2} & ( 17 )\end{matrix}$$

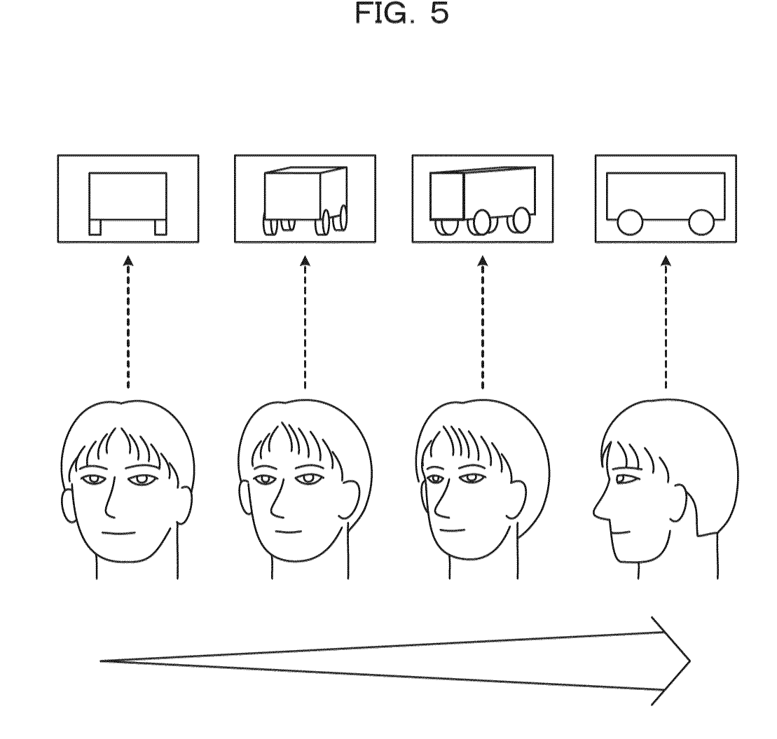

An example of a change in an object image displayed on a screen in response to a change in position of a viewer's eyes will be described. As illustrated in FIG. 5, when a viewer turns his/her head sideways, the object image (an automobile in FIG. 5) displayed on the screen rotates sideways as well.

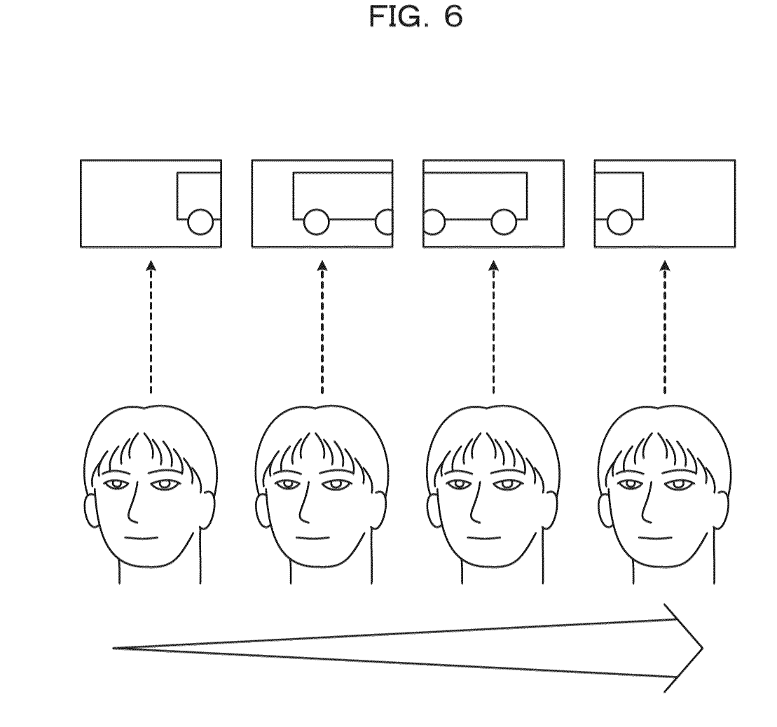

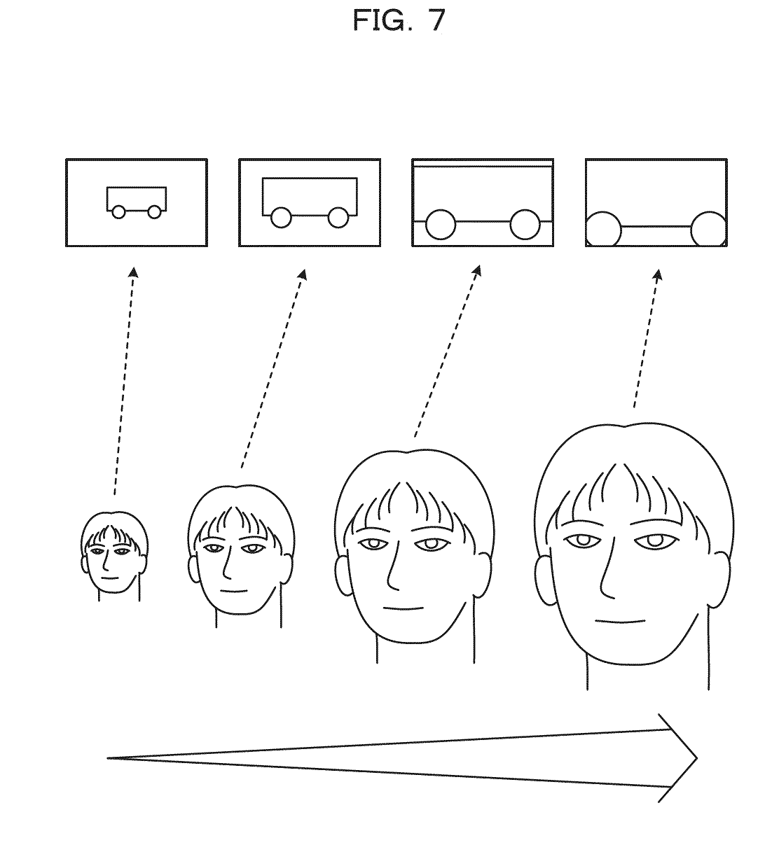

As exemplified in FIG. 6, when a viewer moves his/her face horizontally, an image controller 1 detects the position of the viewer's eyes, and horizontally scrolls the object displayed on the screen. As illustrated in FIG. 7, when a viewer moves his/her face closer to the screen, the object image displayed on the screen is enlarged.

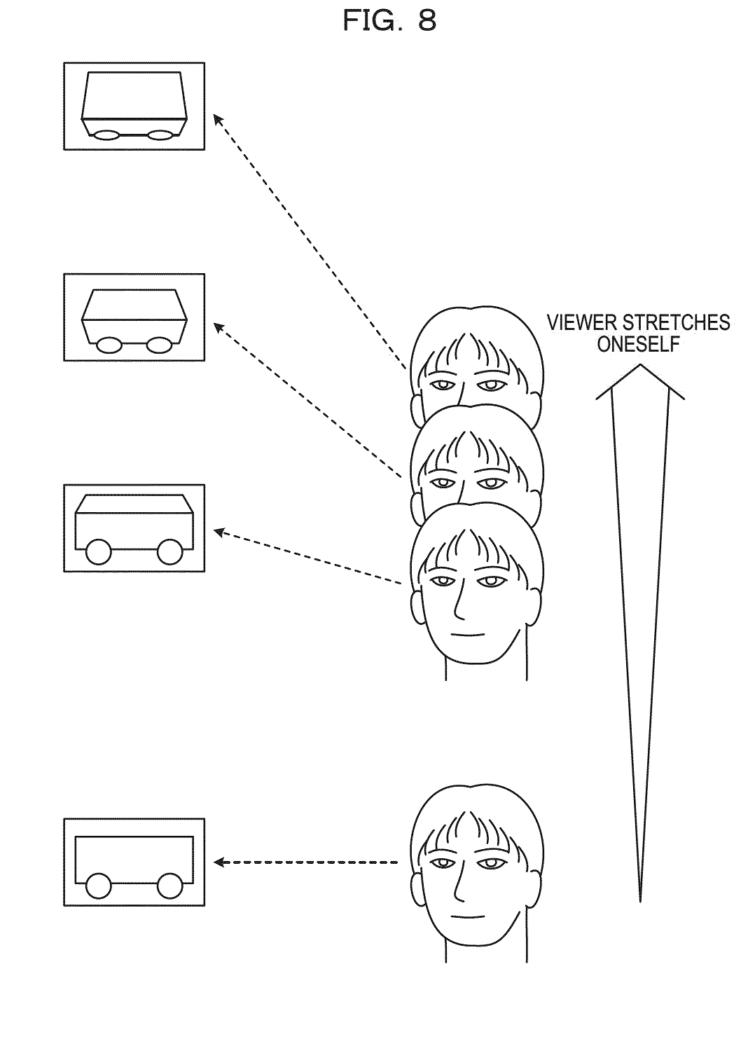

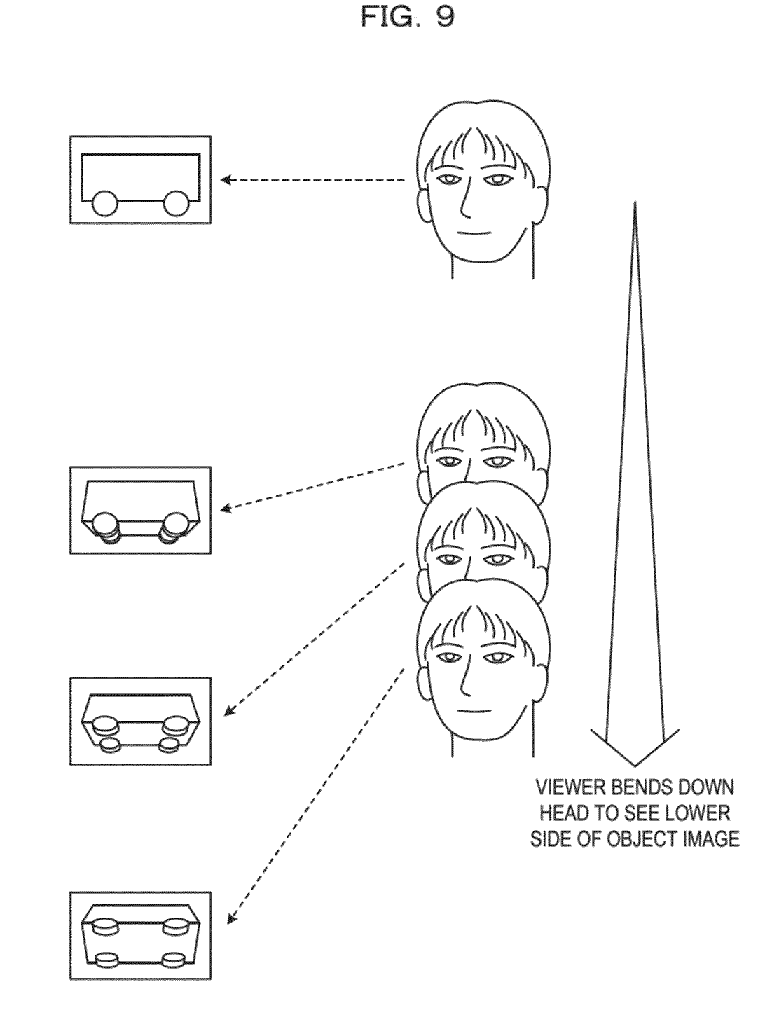

As illustrated in FIG. 8, when the viewer moves his/her face upward, the object displayed on the screen rotates so that the upper part of the object image may be seen. As illustrated in FIG. 9, when the viewer moves his/her face downward, the object displayed on the screen rotates so that the lower part of the object image may be seen.

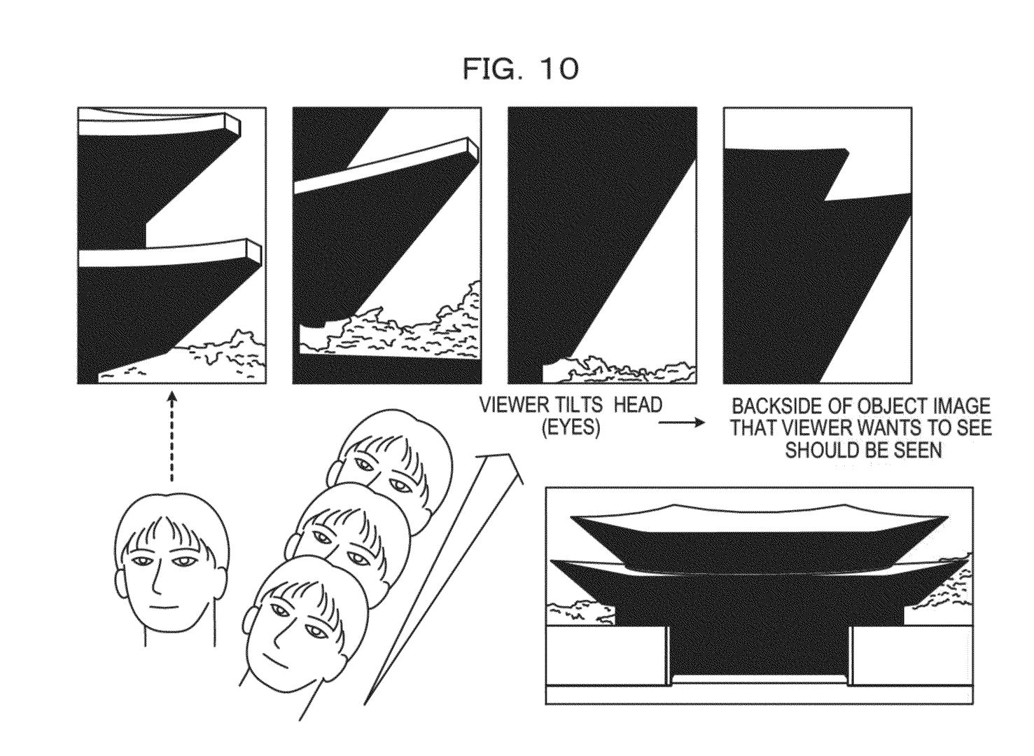

As illustrated in FIG. 10, when a viewer tilts his/her head sideways, the object image displayed on the screen rotates so that the backside of the image may be seen. Thus, controlling the movement or rotation of an object image displayed in response to a change in the position of the viewer's face or eyes allows the object image to be sterically controlled.

The image display unit 30 displays images stored in the TV screen memory 22b of the information processing unit 20. The image display unit 30 includes an image display screen 31 and a awareness TV rack 32. The image display screen 31 is controlled by the above described TV image control unit 21d, and displays a part of all the circumferential panorama images stored in the TV screen memory 22b.

An input-output I/F 40 is an interface for inputting and outputting data. For example, the I/F 40 is an interface for receiving an instruction to detect a awareness TV function that is an instruction from a user to start image control processing, and receiving, from a user, a setting of an interval to detect a position of a viewer's eyes. According to the detection interval (for example, one second) received by the input-output I/F 40, the above described eye position detection unit 21c detects the position of a main viewer's eyes.

Image Control Processing

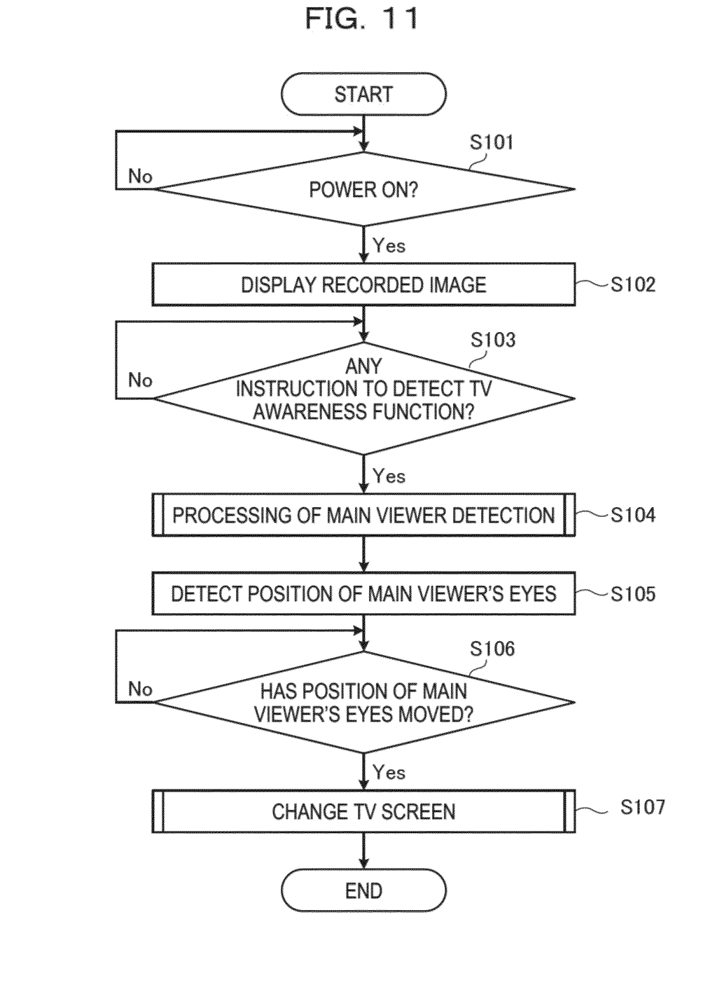

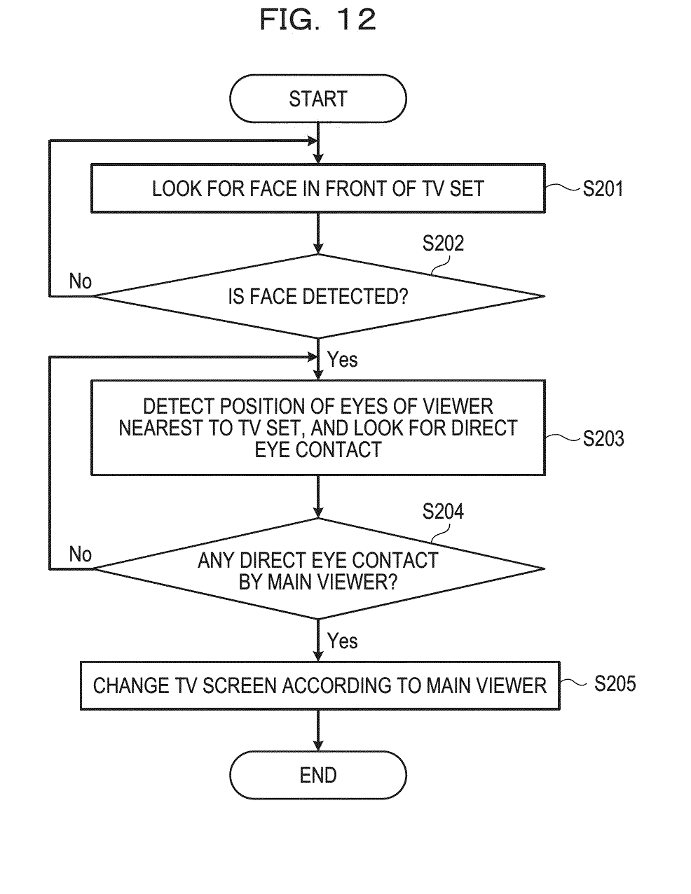

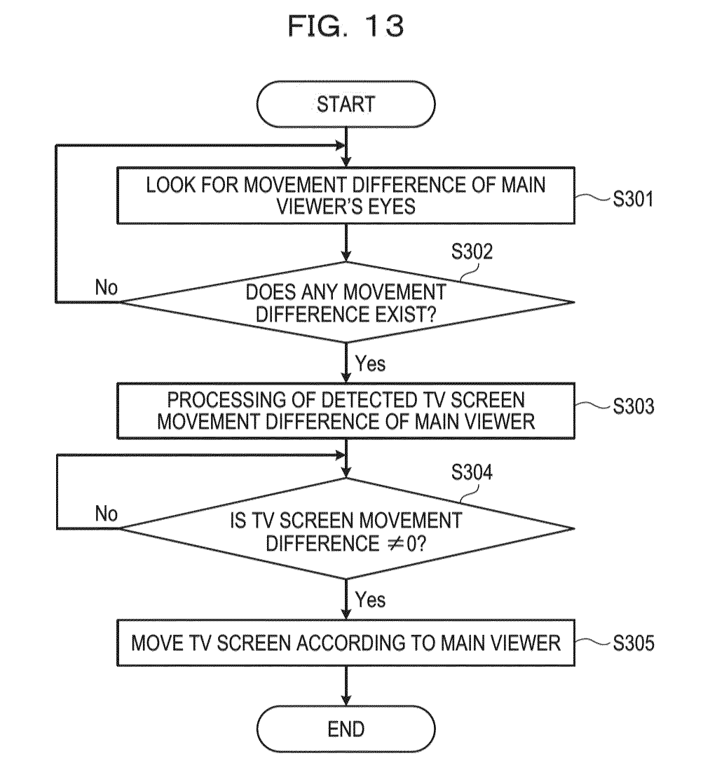

Now referring to FIG. 11 through FIG. 13, processing by an image controller 1 according to a first embodiment will be described. FIG. 11 is a flowchart illustrating overall processing procedures of an image controller according to the first embodiment. FIG. 12 is a flowchart illustrating processing procedures of detecting a main viewer by the TV image controller according to the first embodiment. FIG. 13 is a flowchart illustrating processing procedures of controlling a TV screen by the image controller according to the first embodiment.

As illustrated in FIG. 11 through FIG. 13, when power is turned on (Operation S101: Yes), the image controller 1 displays a recorded image stored in the TV screen memory 22b (Operation S102). When the image controller 1 receives an instruction to detect a awareness TV function (Operation S103: Yes), the image controller 1 executes a main viewer detection processing (described later in detail by referring to FIG. 12) to detect a main viewer among a plurality of viewers (Operation S104).

The image controller 1 detects a position of the main viewer's eyes (Operation S105), and determines whether or not the position of the main viewer's eyes has moved (Operation S106). If the position of the main viewer's eyes has moved (Operation S106: Yes), the image controller 1 assumes that changing a screen is instructed and performs image control processing (described in detail later by referring to FIG. 13) and changes the TV screen (Operation S107) accordingly.

Now, a main viewer detection processing by an image controller 1 will be described by referring to FIG. 12. As illustrated in FIG. 12, the image controller 1 looks for a face in front of the video camera 10 (Operation S201), and determines whether or not the face is detected (Operation S202).

When the image controller 1 determines that the face is detected (Operation S202: Yes), the image controller 1 detects the person nearest to the image display unit 30 as a main viewer, detects the position of the eyes of the main viewer, looks for direct eye contact by the main viewer (Operation S203), and determines if there is direct eye contact by the main viewer (Operation S204). In other words, the image controller checks whether or not the main viewer is gazing directly at the screen on which an image is displayed.

If the image controller 1 determines that direct eye contact exists (Operation S204: Yes), the image controller 1 initiates the processing for controlling an object image displayed on a screen in response to a change in the position of the eyes of the main viewer (Operation S205).

Now, processing of TV image control by the image controller 1 will be described by referring to FIG. 13. As illustrated in FIG. 13, the image controller 1 looks for a movement difference of the main viewer's eyes (Operation S301), and if any movement difference exists (Operation S302: Yes), calculates the TV screen movement difference (Operation S303), and determines whether or not the calculated TV screen movement difference is equal to 0 (Operation S304).

When the TV screen movement difference is not equal to 0 (Operation S304: Yes), the image controller 1 controls the object image displayed on the screen in response to the TV screen movement difference (Operation S305).

Effect of the First Embodiment

As described above, the image controller 1 detects a position of the viewer's face or eyes, and controls an object image displayed on a screen in response to a change in the position of the face or eyes. Thus, controlling the movement or rotation of an object image displayed on a screen in response to a change in the position of viewer's face or eyes enables the image controller 1 to control the object sterically and to intuitively operate various operations while reducing burden on an operator.

According to the first embodiment, a given interval for detecting a position of a face or eyes is received and the position of the viewer's face and eyes is detected at the given interval. Thus, a frequency of changing an image may be adjusted.

### Second Embodiment

An embodiment of this disclosure has been described. However, the present invention is not limited to the above-disclosed embodiment and the present invention may be achieved by various modifications to the above embodiment without departing from the concept of the present invention. Thus, a second embodiment of the invention will be described, hereunder.

(1) Image Control

In this embodiment, an image may be controlled by using a viewer's line of sight as well. An image controller detects a position of a viewer's line of sight and determines whether or not the position of the detected line of sight is within a screen. If the detected line of sight is within the screen, the image controller controls an image in response to a change in the position of the face or eyes.

If the position of the detected line of sight is not within the screen, the image controller 1 stops controlling the image. In other words, the image controller 1 does not control the image if the line of sight is not within the screen assuming that the viewer moves his/her face or eyes without any intention to operate the screen.

As described above, a viewer's line of sight is detected and when the position of the detected line of sight is within a screen, an image is controlled in response to a change in the position of the face or eyes, and when the position of the detected line of sight is not within a screen, controlling the image is stopped. Thus, malfunctions may be reduced if not prevented.

(2) System Configuration, etc.

Components of respective devices illustrated in the figures include functional concepts, and may not necessarily be physically configured as illustrated. Thus, the decentralization and integration of the components are not limited to those illustrated in the figures and all or some of the components may be functionally or physically decentralized or integrated according to each kind of load and usage. For example, a face detection unit 21a and a face recognition unit 21b may be integrated. All or a part of the processing functionality implemented by the components may be performed by a CPU and a program that is analyzed and executed by the CPU, or may be implemented as hardware with wired logic.

Among processing described in the above embodiment, an entire or a part of processing that is explained as automatic processing may be manually performed, and the processing explained as manual processing may be automatically performed. Moreover, processing procedures, control procedures, specific names, and information that includes various data or parameters may be optionally changed unless otherwise specified.

(3) Program

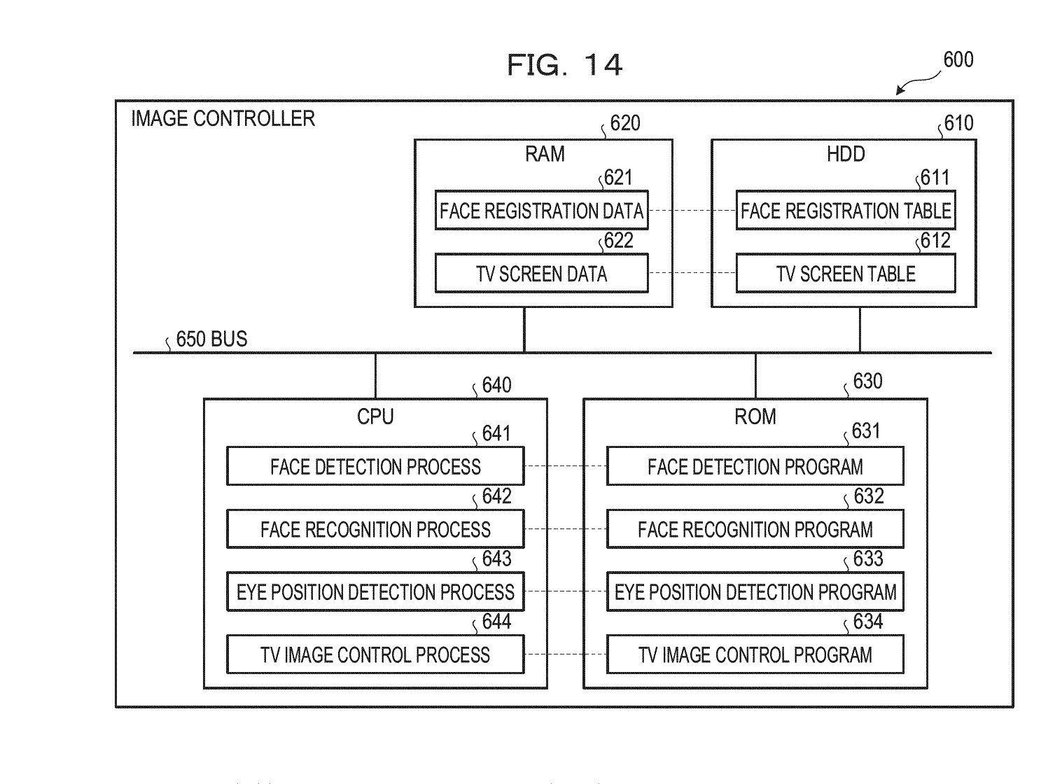

Various processing described in the above embodiments may be achieved by causing a computer system to execute a prepared image control program. Therefore, an example of a computer system executing a program that has similar functions as the above embodiment will be described below by referring to FIG. 14. FIG. 14 illustrates a computer executing the image control program.

As illustrated in FIG. 14, a computer 600 as an image controller includes a hard disk drive (HDD) 610, a Random Access Memory (RAM) 620, a Read-Only Memory (ROM) 630, and a Central Processing Unit (CPU) 640, and each of these are connected via a bus 650.

The ROM 630 stores an image control program that provides the similar functions as the above embodiments. In other words, the ROM 630 stores a face detection program 631, a face recognition program 632, an eye position detection program 633, and a TV image control program 634 as illustrated in FIG. 14. The programs 631 to 634 may be appropriately integrated or distributed as in each of the components of the image controller illustrated in FIG. 1.

Reading and executing the programs 631 to 634 from the ROM 630 by the CPU 640 makes each of the programs 631 to 634 function as a face detection process 641, a face recognition process 642, an eye position detection process 643, and a TV image control process 644 respectively as illustrated in FIG. 14. The processes 641 to 644 correspond to the face detection unit 21a, the face recognition unit 21b, the eye position detection unit 21c, and the TV image controller 21d respectively illustrated in FIG. 1.

The HDD 610 provides a face registration table 611, and a TV screen table 612 as illustrated in FIG. 14. The face registration table 611 corresponds to the face registration memory 22a, and the TV screen table 612 corresponds to the TV screen memory 22b illustrated in FIG. 1. The CPU 640 registers data to the face registration table 611 and the TV screen table 612, and the CPU 640 also reads face registration data 621 from the face registration table 611 and TV screen data 622 from the TV screen table 612, and stores the data in the RAM 620, and executes processing based on the face registration data 621 and the TV screen data 622 stored in the RAM 620.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An image controller comprising:
a position detection unit which detects a position of a viewer; and
an image control unit which controls an object image displayed on a screen in response to a change in the position detected by the position detection unit.

2. The image controller according to claim 1, further comprising:
a detection interval settings receiving unit which receives a setting of an interval for detecting the position by the position detection unit, wherein the position detection unit detects the position at the interval set by the detection interval settings receiving unit.

3. The image controller according to claim 1, further comprising:
a line of sight detection unit which detects the position of the viewer's line of sight, wherein the image control unit controls the image in response to a change in the position detected by the position detection unit if the line of sight detected by the line of sight detection unit is within the screen, or the image controller stops controlling the image if the line of sight detected by the line of sight detection unit is outside the screen.

4. The image controller according to claim 1, wherein the position detection unit detects a position of the viewer's face or eyes as the position.

5. A recording medium recording an image control program to be executed to perform processes comprising:
detecting a position of a viewer; and
controlling an image displayed on a screen in response to a change in the position detected by the detecting.

6. The recording medium recording the image control program to be executed, according to claim 5, to further perform processes comprising:
receiving a setting of an interval for detecting the position by the detecting;
wherein the detecting detects the position at the interval received by the receiving.

7. The recording medium recording an image control program to be executed, according to claim 5, to further perform processes comprising:
detecting a line of sight of the viewer, wherein the controlling controls the image in response to a change in the position detected by the detecting if the line of sight detected by the detecting is within the screen, or the controlling stops controlling the image if the line of sight detected by the detecting is outside the screen.

8. The image controller according to claim 5, wherein the detecting detects a position of the viewer's face or eyes as the position.

9. An image control method executed by a computer, the method comprising:
detecting a position of a viewer; and
controlling an object image displayed on a screen in response to a change in the position detected by the detecting.

10. The image control method according to claim 9, further comprising:
receiving a setting of an interval for detecting the position by the detecting, wherein the detecting detects the position at the interval received by the receiving.

11. The image control method according to claim 9, further comprising:
detecting a line of sight of the viewer, wherein the controlling controls the image in response to a change in the position detected by the detecting if the line of sight detected by the detecting is within the screen, or stops controlling the image if the line of sight detected by the detecting is outside the screen.

12. The image controller according to claim 9, wherein the detecting detects a position of the viewer's face or eyes as the position.
